(19) United States
(12) Patent Application Publication
(10) Pub. No.: US 2024/0217814 A1
(43) Pub. Date: Jul. 4, 2024

(54) PROCESS AND SYSTEM FOR PROVIDING HYDROGEN GAS

(71) Applicant: HYDROGENIOUS LOHC TECHNOLOGIES GMBH, Erlangen (DE)

(72) Inventors: Alexander PFLÜGER, Oberasbach (DE); Katharina WIELAND, Nürnberg (DE); Alexander SEIDEL, Erlangen (DE); Alexander WEISS, Möhrendorf (DE); Caspar PAETZ, Erlangen (DE); Holger BÜCH, Erlangen (DE)

(21) Appl. No.: 18/555,923

(22) PCT Filed: Apr. 14, 2022
(86) PCT No.: PCT/EP2022/060063

§ 371 Date: Oct. 18, 2023

(30) Foreign Application Priority Data
Apr. 19, 2021 (DE) 10 2021 203 885.9

(51) Int. Cl. C01B 3/22; B01D 15/08; B01J 20/08; B01J 20/34

(52) U.S. Cl. CPC C01B 3/22; B01D 15/08; B01J 20/08; B01J 20/3458; B01J 20/3475

(57) ABSTRACT

A method for providing hydrogen gas includes providing a liquid hydrogen carrier material, removing oxygen-carrying and/or sulfur-carrying and/or halogen-containing components from the liquid hydrogen carrier material, releasing hydrogen gas by catalytic dehydrogenation of the purified hydrogen carrier material, and conditioning the released hydrogen gas.

### CROSS-REFERENCES TO RELATED APPLICATIONS

This application claims the priority of German Patent Application, Serial No. 10 2021 203 885.9, filed 19 Apr. 2021, the content of which is incorporated herein by reference in its entirety as if fully set forth herein.

### FIELD OF THE INVENTION

The invention relates to a method and a system for providing hydrogen gas.

### BACKGROUND OF THE INVENTION

The provision of hydrogen gas, in particular by catalytic dehydrogenation of a hydrogen carrier material, is known from DE 10 2016 222 596 A1. The released hydrogen gas may contain impurities that have to be removed in a subsequent purification step, in particular by pressure swing adsorption. The application of pressure swing adsorption is complex in terms of process engineering and causes losses in the released hydrogen gas, which limits the economic efficiency of the overall process. Further dehydrogenation methods are known from DE 10 2014 006 430 A1 and DE 10 2006 013 037 A1. According to DE 10 2014 006 430 A1, oxygen-containing components are deliberately added to the hydrogen carrier material in order to be able to utilize them thermally after separation. This is intended to reduce the total heat demand. The disadvantage is that despite the separation of the oxygen-containing compounds, oxygen-containing impurities are still present in the hydrogen carrier material.

### SUMMARY OF THE INVENTION

It is an object of the invention to improve the provision of hydrogen, in particular by catalytic dehydrogenation of a hydrogen carrier material, in particular to increase the economic efficiency of the hydrogen gas provision and/or to increase the purity of the hydrogen gas provided.

This object is achieved according to the invention by a method for providing hydrogen gas comprising the method steps of
providing a liquid hydrogen carrier material,
removing oxygen-carrying and/or sulfur-carrying and/or halogen-containing components from the liquid hydrogen carrier material,
releasing hydrogen gas by catalytic dehydrogenation of the purified hydrogen carrier material,
conditioning the released hydrogen gas.

This object is further achieved by a system for providing hydrogen gas comprising
a. a first removal unit for removing oxygen-carrying and/or sulfur-carrying and/or halogen-containing components from liquid hydrogen carrier material,
b. a dehydrogenation reactor for releasing hydrogen gas by catalytic dehydrogenation of the hydrogen carrier material,
c. a second removal unit for conditioning the released hydrogen gas.

The essence of the invention is that in a first purification step, oxygen-carrying and/or sulfur-carrying and/or halogen-containing components are removed from a liquid hydrogen carrier material. Surprisingly, it has been found that the oxygen-carrying and/or halogen-containing and/or sulfur-carrying components in the liquid hydrogen carrier material cause impurities in the subsequently released hydrogen gas in the further process chain, wherein these impurities would have to be removed from the hydrogen gas with disproportionately high effort. The first purification step is carried out with the hydrogen carrier material in the liquid phase. It has been found that this first purification step is particularly efficient with respect to the overall method. This first purification step represents a preliminary purification. In particular, not all oxygen-carrying and/or sulfur-carrying and/or halogen-containing components are removed in this first purification step.

In particular, the removal of the oxygen-carrying and/or sulfur-carrying and/or halogen-containing impurities is carried out without an evaporation step and in particular without a distillation. It has been recognized that a separation by distillation according to DE 10 2014 006 430 A1 for the comparatively small amounts according to the invention is costly to carry out and in particular uneconomical. According to the invention, it has been recognized that alternative removal steps are more suitable for the separation, in particular of the oxygen-carrying impurities, and that the overall efficiency of the process can thereby be increased.

The proportion of oxygen-carrying components, in particular including water, prior to the first purification step is at most 20,000 ppmw, in particular at most 15,000 ppmw, in particular at most 12,000 ppmw, in particular at most 10,000 ppmw, in particular at most 8,000 ppmw and in particular at most 5,000 ppmw.

The proportion of oxygen-carrying components, in particular including water, is reduced in the first purification step to at most 1,000 ppmw, in particular at most 500 ppmw, in particular 100 ppmw, in particular at most 50 ppmw and in particular at most 10 ppmw.

The proportion of sulfur-carrying components prior to the first purification step is at most 200 ppmw, in particular at most 150 ppmw, in particular at most 100 ppmw, in particular at most 80 ppmw and in particular at most 50 ppmw. The proportion of sulfur-carrying components is reduced in the first purification step to at most 0.5 ppmw, in particular to at most 0.1 ppmw, in particular to at most 0.05 ppmw and in particular to at most 0.01 ppmw.

The proportion of halogen-containing components prior to the first purification step is at most 200 ppmw, in particular at most 150 ppmw, in particular at most 100 ppmw, in particular at most 80 ppmw and in particular at most 50 ppmw. The proportion of halogen-containing components is reduced in the first purification step to at most 10 ppmw, in particular to at most 1 ppmw and in particular to 0.1 ppmw.

The oxygen-carrying and/or sulfur-carrying and/or halogen-containing components that are removed from the liquid hydrogen carrier material reduce the effort required for subsequent purification of the released hydrogen gas. The total effort for purification is thus reduced.

In particular, a liquid organic hydrogen carrier (LOHC), in particular cyclic hydrocarbon compounds, in particular based on benzyltoluene and/or dibenzyltoluene and/or their isomer mixtures, in particular N-ethylcarbazole, fluorene, indoline, diphenylmethane, biphenyl, serves as hydrogen carrier material. In particular, a mixture of biphenyl and diphenylmethane has proven to be advantageous, in particular in a ratio of 40:60, in particular 35:65 and in particular 30:70. In the first purification step, in particular liquid hydrogen carrier material is used which is at least partially in a discharged state (LOHC-D). In the first purification step, hydrogen carrier material which is of technical quality (LOHC-V) can also be used. LOHC-V is understood to mean in particular fresh hydrogen carrier material that originates from the production process and in particular has not yet been hydrogenated. LOHC-V is in particular completely aromatic, i.e. it has in particular exclusively aromatic hydrocarbon compounds. The hydrogenation degree of LOHC-V is in particular 0%. LOHC-D is at least partially dehydrogenated hydrogen carrier material, i.e. it can also have proportionally hydrogenated and/or partially hydrogenated molecules. Due to the upstream manufacturing process, LOHC-V may comprise impurities that do not occur in LOHC-D or occur in reduced amounts. Such impurities are in particular halogen-containing and/or oxygen-containing and/or sulfur-carrying impurities. The purification of LOHC-V in the first purification step has proven to be particularly efficient for the overall method. The hydrogenation degree of LOHC-D is in particular between 5% and 20%.

The oxygen-carrying components removed from the liquid hydrogen carrier material are referred to as oxygenates and may include variously substituted phenols, carbonyls and/or carboxylic acids. One oxygen-carrying component in particular is water.

Sulphur-carrying components removed from the liquid hydrogen carrier material are in particular thiols, mercaptans, benzothiphenes and dibenzothiophenes.

Halogen-containing impurities removed from the liquid hydrogen carrier material are in particular benzyl chloride, chlorobenzene and hydrochloric acid (HCl) and in particular chlorine-containing derivatives of benzyltoloule and/or diphenylmethane.

During hydrogenation and/or dehydrogenation of the liquid hydrogen carrier material, the oxygenates are deoxygenated while splitting off carbon monoxide (CO) and/or water, wherein the water thus formed can reform hydrocarbons at dehydrogenation conditions to carbon monoxide (CO) and/or carbon dioxide (CO₂). Due to the removal of these components in the first purification step, the amount of carbon monoxide and/or carbon dioxide in the released hydrogen gas can be efficiently reduced. In particular, it can be done at low expense and effort. In particular, it has been recognized that the hydrogen purity defined for its use in fuel cells in DIN EN 17124: 2019-07 or for hydrogen as a fuel in ISO 14687: 2019-11 can be complied with in an uncomplicated manner.

In particular, it is possible to convert the oxygen-containing components in an intermediate step, i.e. to convert them into other oxygen-containing components, which are then removed. For example, it is possible to convert carbon monoxide (CO) into carbon dioxide (CO₂) and/or to convert carbon monoxide (CO) into methane (CH₄) and water. In particular, it has been found that the limits for impurities defined according to ISO 14687: 2019-11 are set differently. For example, the maximum allowable proportions are 100 ppmv for methane and 0.2 ppmv for carbon monoxide. By selectively converting, for example, carbon monoxide into methane, it is possible to provide the purity required by the standard for the fuel without having to separate a carbon compound. The effective effort to maintain the required purity is thus reduced.

A further finding of the invention is based on the fact that in the hydrogen gas released by catalytic dehydrogenation of the hydrogen carrier material (LOHC), in particular in the at least partially charged form (LOHC-H), can be efficiently purified in a second purification step. The second purification step comprises conditioning of the released hydrogen gas, i.e. takes place in the gas phase. Since a pre-purification has already taken place in the first purification step, the purification effort in the second purification step is reduced. In particular, due to the pre-purification of the liquid hydrogen carrier material, no or only small amounts of oxygen-containing, sulfur-containing and/or halogen-containing impurities are present in the released hydrogen gas. It has been found that the second purification step enables targeted and selective removal of impurities. In particular, it has been found that the pressure swing adsorption that is complex in terms of process-engineering is dispensable for the second purification step, in particular for the removal of oxygen-carrying components that are difficult to remove, in particular carbon monoxide, carbon dioxide and/or water. As the pressure swing adsorption can be avoided, the loss of product hydrogen is reduced, i.e. the yield of product hydrogen is increased.

The economic efficiency of the method is increased. The released hydrogen gas has an increased purity and is particularly suitable for the use in a fuel cell, in particular in a motor vehicle. In particular, in the released hydrogen gas the carbon monoxide content is less than 0.2 ppmv, and/or the proportion of sulfur-carrying components, in particular hydrogen sulfide, is less than 0.004 ppmv, the proportion of water is less than 5 ppmv, the proportion of oxygen is less than 5 ppmv, the proportion of carbon dioxide is less than 2 ppmv, the proportion of formaldehyde is less than 0.02 ppmv and/or the proportion of formic acid is less than 0.2 ppmv. In particular, the proportion of further impurities, in particular free of oxygen and/or sulfur, such as in particular methane, is less than 100 ppmv. Other hydrocarbon compounds are less than 2 ppmv in the released hydrogen gas. In the released hydrogen gas, the proportion of halogen-containing components is in particular less than 0.05 ppmv.

In particular, the method makes it possible to provide hydrogen gas in fuel cell quality and, in particular, to reduce the overall effort required to provide hydrogen gas in fuel cell quality.

By eliminating the need for pressure swing adsorption, in particular at least in part and in particular for the removal of the difficult-to-remove sulfur-containing and/or oxygen-containing components in the released hydrogen gas, the yield of the method, i.e. the volume flow rate of the released hydrogen gas per volume flow rate of the liquid hydrogen carrier material (LOHC) used, is increased. In particular, it has been found that the loss of hydrogen gas in pressure swing adsorption can be reduced by up to 60% if carbon monoxide has been substantially purified in the first purification step. The total loss of hydrogen gas as a result of the pressure swing adsorption is thereby reduced to at most 4%, in particular at most 3%, in particular at most 2% and at most in particular 1%.

The adsorption of the oxygen-carrying and/or sulfur-carrying and/or halogen-containing components from the liquid hydrogen carrier material has proven to be particularly efficient. Additionally or alternatively, it is possible to remove water as a physically dissolved oxygen-carrying component from the hydrogen carrier material (LOHC), in particular by drying.

A method comprising the use of at least one polar, in particular oxidic, adsorbent has proven to be particularly efficient in removing oxygen-carrying components. In particular, Al₂O₃, SiO₂, zeolites and/or an adsorbent based on activated carbon serve as adsorbents.

A method comprising a regeneration of the polar adsorbent by means of a purge gas stream and/or a solvent stream has proven to be particularly sustainable. In particular, the method enables the regular purification of the adsorbent, in particular the removal of the oxygen-carrying and/or sulfur-carrying components from the adsorbent. In particular, a closed solvent circuit can be established, wherein the impurities dissolved with the solvent, in particular oxygenates, can be separated from the solvent by distillation. The solvent itself can thus be reused. In particular, a low-boiling substance, such as acetone, isopropanol and/or ethyl acetate, serves as the solvent. It is advantageous if the solvent has a polarity that is stronger than the polarity of the adsorptive/adsorbate molecules.

In particular, an inert gas, in particular nitrogen (N₂), serves as the purge gas. Additionally or alternatively, hydrogen gas can also serve as the purge gas, which can be provided in particular by electrolysis.

The first purification step including the conditions, in which the removal of the oxygen-carrying and/or sulfur-carrying and/or halogen-containing components from the liquid hydrogen carrier material is carried out at a temperature of at most 350° C., in particular at most 200° C. and in particular at most 100° C. and/or at a pressure of at most 50 bara, in particular at most 35 bara, in particular at most 20 bara and in particular at most 5 bara, has proven to be particularly efficient.

The performance of the second purification step, in which the conditioning comprises removing oxygen-carrying and/or sulfur-carrying components from the released hydrogen gas, has proven to be particularly efficient in purifying the released hydrogen gas. The second purification step comprises removing oxygen-carrying and/or sulfur-carrying components from the released hydrogen gas. In particular, an oxygen-carrying component of the released hydrogen gas is carbon monoxide (CO). In particular, it has been found that carbon monoxide can be advantageously and efficiently converted by means of a copper compound and/or by means of a zinc compound, in particular by means of copper oxide (CuO) and/or zinc oxide (ZnO). In particular, carbon monoxide can be converted with copper oxide to form elemental copper and carbon dioxide. A sulfur-carrying component of the released hydrogen gas is in particular hydrogen sulfide (H₂S).

In particular, it has been found that adsorption, in particular pressure swing adsorption, efficiently enables the removal of hydrocarbon compounds from the hydrogen gas.

Additionally, or alternatively, the oxygen-carrying and/or sulfur-carrying components can be removed from the hydrogen gas by catalytic purification.

The conditioning of the hydrogen gas may additionally or alternatively comprise a removal of hydrocarbon compounds. The conditioning of the released hydrogen gas additionally or alternatively comprises the separation of liquid components from the hydrogen gas, in particular liquid components of the hydrogen carrier material. The separation may in particular be preceded by cooling in order to cool and/or condense the hydrogen carrier material, which is in particular initially in vapor form. This simplifies the subsequent separation of the liquid components from the hydrogen gas stream.

In particular, the use of an adsorbent, which is in particular selective, enables a targeted removal of the oxygen-carrying and/or sulfur-carrying components.

Additionally, or alternatively, nickel-based and/or copper-based adsorber materials can be used to remove the sulfur-carrying components from the liquid hydrogen carrier material.

For the removal of halogen-containing and/or chlorine-containing hydrocarbon compounds from the liquid hydrogen carrier material, zinc oxide and/or calcium hydroxide in particular serve as adsorber material.

A performance of the second purification step comprising removing the oxygen-carrying and/or sulfur-carrying components from the released hydrogen gas by means of catalysis, in particular by using at least one selective catalyst material, in particular comprising nickel, copper, cobalt, molybdenum and/or noble metal, has been found to be particularly efficient. In particular, it has been found that a selective removal of carbon monoxide and/or hydrogen sulfide is advantageously possible. For example, selective methanation serves to convert carbon monoxide in a targeted manner:

CO+3H₂→H₂O+CH₄

The catalyst material for methanation comprises in particular a metal, in particular nickel, copper, cobalt, molybdenum and/or a noble metal, in particular ruthenium, platinum and/or palladium. The catalyst material is in particular attached to a carrier material. The carrier material is in particular inert and/or porous. The carrier material is in particular aluminum oxide, silicon oxide, zinc oxide and/or zeolite. For the methanation of carbon monoxide (CO) to methane (CH₄), a temperature range of at least 100° C. and in particular between 100° C. and 200° C. is advantageous.

The targeted removal of hydrogen sulfide is possible using copper oxide:

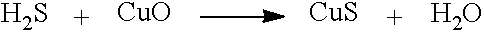

The reduction of copper oxide can be carried out by means of hydrogen sulfide and/or carbon monoxide and/or hydrogen gas. It is a stoichiometric reaction in which copper oxide is consumed.

Performing the second purification step, in which the removal of the oxygen-carrying and/or sulfur-carrying components from the released hydrogen gas takes place at a temperature of at most 350° C., in particular at most 200° C. and in particular at most 100° C. and/or at a pressure of at most 800 bara, in particular at most 400 bara, in particular at most 50 bara and in particular at most 5 bara, has proven to be particularly advantageous.

A method comprising a storage and/or transport of the purified liquid hydrogen carrier material which is protected, in particular from external influence, in particular a protected transport of the purified liquid hydrogen carrier material from a first location, where the oxygen-carrying and/or the sulfur-carrying and/or the halogen-containing components have been removed from the liquid hydrogen carrier material, to a second location, where the hydrogen gas is released, enables a temporal and/or spatial separation of the first purification step from the second purification step. In the case of sealed storage and/or sealed transport of the liquid hydrogen carrier material, it is ensured that no new, additional contamination of the purified liquid hydrogen carrier material takes place after the first purification step. In particular, it is thereby possible that the first purification step of the liquid hydrogen carrier material (LOHC) takes place in particular at a first location, in particular at a high-energy location. At the high-energy location, hydrogenation of the hydrogen carrier material, i.e. at least partial charging of the hydrogen carrier material, can take place in particular immediately after the first purification step. The thus purified and charged hydrogen carrier material (LOHC-H*) can then be transported from the first location to a second location, which is in particular comparatively low in energy. At the second location, the dehydrogenation of the purified, at least partially charged hydrogen carrier material (LOHC-H*) can take place. The impurities can then be removed from the released hydrogen gas in the second purification step.

In particular, the liquid hydrogen carrier material is stored and/or transported under a gas atmosphere after the first purification step. The gas used for the gas atmosphere is an inert gas. The inert gas is in particular free of oxygen, sulfur and/or chlorine.

A method, in which oxygen-carrying components in the released hydrogen gas are less than 200 ppmv, in particular less than 100 ppmv, in particular less than 10 ppmv, in particular less than 1 ppmv and in particular less than 0.2 ppmv and/or sulfur-carrying components in the released hydrogen gas are less than 1 ppmv, in particular less than 0.1 ppmv, in particular less than 0.01 ppmv and in particular less than 0.001 ppmv, guarantees the provision of released hydrogen gas with high purity.

A system according to the invention essentially has the advantages of the method according to the invention, to which reference is hereby made. Essential components of the system according to the invention are a first removal unit, which can in particular be arranged at a first, in particular high-energy, location, and a second removal unit, which can be arranged at a second, in particular low-energy, location. In particular, the first and the second location are arranged at a spatial distance from each other, in particular several kilometers, in particular several tens of kilometers, in particular several hundred kilometers and in particular several thousand kilometers.

The first and second removal units can also be arranged adjacent to each other and in particular spatially adjacent. In particular, the two removal units are arranged in one and the same system and in particular at one and the same location and are in particular operated alternately.

The system comprises a dehydrogenation reactor to release hydrogen gas by catalytic dehydrogenation of the hydrogen carrier material (LOHC), in particular in the at least partially charged form (LOHC-H).

The system according to the invention has at least one first removal unit. In particular, several first removal units may be provided. The first removal units can be arranged parallel and/or sequentially to one another along a fluid flow direction and can be interconnected.

A system, in which the first removal unit is a first adsorber unit comprising a polar, in particular oxidic, adsorbent, enables the first purification step to be carried out particularly efficiently.

A system, in which a solvent line and in particular a distillation unit connected thereto are connected to the first adsorber unit, or in which a purge gas line is connected to the first adsorber unit, enables a permanent and in particular sustainable use of the system. In particular, the solvent line is designed as a closed circuit line. In particular, a heating source is connected to the first removal unit. The heating source simplifies the cleaning of the first removal unit from the solvent.

A system comprising a hydrogenation reactor which is fluidically connected in particular to the first adsorber unit ensures that purified hydrogen carrier material is used for the reversible hydrogenation/dehydrogenation cycle.

Both the features indicated above and the features indicated in the embodiment example of a system according to the invention are each suitable, alone or in combination with one another, for further embodying the subject-matter according to the invention. The respective combinations of features do not constitute a restriction with regard to the further embodiments of the subject-matter of the invention, but are essentially merely exemplary in character.

Further features, advantages and details of the invention will be apparent from the following description of an embodiment example based on the drawing.

### BRIEF DESCRIPTION OF THE DRAWING

FIG. 1 shows a schematic representation of a system according to the invention.

### DESCRIPTION OF THE PREFERRED EMBODIMEMT

A system marked 1 in total comprises a first system part 2 and a second system part 3 connected thereto. The connection between the system parts 2, 3 is indicated by the arrows 4.

According to the embodiment example shown, the first system part 2 is arranged at a first location, in particular at a high-energy location. At the high-energy location there is a surplus of energy or energy is available at comparatively low costs. In particular, a power source for generating electric current is arranged at the high-energy location, in particular for generating electric current from renewable energies such as wind power and/or solar power. High-energy can also mean that there is a surplus of thermal energy at the first location, in particular hydrogenation heat, which can be used for purification of an adsorber material.

The second system part 3 is arranged at a second location, which is in particular spatially distanced from the first location. The second location is in particular a low-energy location, in particular a location where there is a demand for energy and/or energy is available at comparatively high costs.

The connections 4 serve to connect the first system part 2 with the second system part 3 and vice versa. The connection direction is symbolized in each case by the arrowhead. The connections 4 can be realized, for example, by connection lines in order to transport hydrogen carrier medium, in particular liquid organic hydrogen carrier material (LOHC) between the system parts 2, 3. In addition or as an alternative to the connection lines, the connections 4 can be realized by transport vehicles, in particular transport trucks, transport trains or transport ships.

In order to simplify the connections 4 with the system parts 2, 3, in particular to standardize them, an input interface 6 and an output interface 7 can be provided on each of the system parts 2, 3. The input interface 6 is formed, for example, by a defined line connection. The input interface 6 can additionally or alternatively have a storage container in order to store the delivered hydrogen carrier medium at the respective system part 2, 3 at least temporarily.

Accordingly, the output interface 7 can be designed with a defined line connection and/or a storage container.

The first system part 2 is explained in more detail below. In the first system part 2, the first energy source 5 is connected to an electrolyzer 9 via an electric line 8. In the electrolyzer 9, water is split into hydrogen gas (H₂) and oxygen gas (O₂) using electric current. In addition or alternatively to the electrolyzer 9, other sources of hydrogen can be provided, in particular hydrocarbon compounds such as natural gas, gasoline and/or methanol, which are reformed. Additionally, or alternatively, hydrogen gas can be produced by gasification of biomass, the Kvaerner method, as well as by means of green algae. The hydrogen gas produced in the electrolyzer 9 is passed through a first heat exchanger 11 by means of a hydrogen line 10 for preheating. Preheating in the first heat exchanger 11 can also be omitted. It is possible to pass the hydrogen stream through further heat exchangers 12 to effect additional preheating of the hydrogen gas.

It may be advantageous to condition the hydrogen gas before further use. Such conditioning comprises in particular compressing the hydrogen gas to a pressure of at least 5 bar, in particular of at least 10 bar, in particular of at least 20 bar, in particular of at least 30 bar, in particular of at least 50 bar, in particular of at least 80 bar, in particular of at least 100 bar and in particular of at most 1,000 bar, and/or drying the hydrogen gas, in particular to an absolute humidity of the hydrogen gas of at most 10,000 ppmv, in particular of at most 1,000 ppmv and in particular of at most 100 ppmv. The absolute humidity is indicated in particular in umol_{H}_{₂}_{O}/mol_{Gas}.

The hydrogen line 10 opens into a hydrogenation reactor 13. The hydrogenation reactor 13 serves to hydrogenate the hydrogen carrier material LOHC. Through the hydrogenation reaction in the hydrogenation reactor 13, at least partially discharged hydrogen carrier material LOHC-D is charged with hydrogen, i.e. hydrogen is chemically bound to the at least partially discharged hydrogen carrier material (LOHC-D). As a result, at least partially charged hydrogen carrier material LOHC-H is formed.

The first system part 2 has a first storage container 14 for at least partially discharged hydrogen carrier material LOHC-D. Additionally or alternatively, hydrogen carrier material of technical quality (LOHC-V) can also be stored in a further, not shown first storage container. The first storage container 14 is connected to the input interface 6 of the first system part 2 via a fluid line 15.

A first removal unit 16 is connected to the first storage container 14 via a fluid line 15 and a first pump 17. The first removal unit 16 is designed as an adsorber unit. An adsorbent, i.e. an adsorber material, is arranged in the first adsorber unit 16. The adsorbent is in particular polar and in particular oxidic. It is particularly advantageous if the first removal unit 16 has two adsorber units. The two adsorber units are in particular arranged in parallel and can in particular be operated alternately. While one adsorber unit is used in an adsorption mode for purifying the hydrogen carrier material LOHC-D and LOHC-V, the other adsorber unit can be cleaned, i.e. regenerated. More than two adsorber units can also be used.

An external heating source 18 is connected to the first adsorber unit 16 in order to heat the first adsorber unit 16, in particular the components arranged therein. The external heating source 18 is in particular an electric heater comprising at least one heating rod. Additionally, or alternatively, the external heating source 18 may be designed as a heat exchanger, which in particular comprises thermal oil as heat exchange medium. Additionally, or alternatively, the external heating source 18 may also be designed as a heat exchanger in which water is heated and evaporated, which cools and/or condenses in the first adsorber unit 16. The heating of the heat transfer medium is carried out in particular by using waste heat from the hydrogenation reactor 13.

The heating source 18 can also be a thermal utilization unit, in particular a combustion unit, in which in particular a fuel, in particular hydrogen, is burnt.

The first adsorber unit 16 is fluidically connected to a second storage container 19, in which at least partially discharged hydrogen carrier material LOHC-D* that has been purified in the first adsorber unit 16 can be stored. The second storage container 19 is connected to the hydrogenation reactor 13 via further fluid lines 15. Along the fluid lines 15, a further pump 17 and/or further heat exchangers 12 may be arranged between the second storage container 19 and the hydrogenation reactor 13. The second storage container 19 can also be omitted, in particular in the event that the first removal unit 16 comprises two parallel adsorber units.

A purge gas line 20 is connected to the first adsorber unit 16. By means of the purge gas line 20, purge gas, in particular inert gas, in particular nitrogen, can be fed to the first adsorber unit in order to purge the adsorbent arranged in the first adsorber unit 16. Alternatively, or additionally, hydrogen gas from the hydrogenation reactor 13 can be used as purge gas. In particular, the purge gas line 20 is connected to the first adsorber unit 16 by means of a valve connection 21 in such a manner that the flow direction of the purge gas through the first adsorber unit 16 is oriented in countercurrent with respect to the fluid flow direction of the hydrogen carrier material through the first adsorber unit 16.

A solvent line 22 is connected to the first adsorber unit 16 via a second valve unit 23. The fluid line that connects the first storage container 14 with the first adsorber unit 16 also opens into the second valve unit 23. At the first valve unit 21, the solvent line 22 branches off from the fluid line 15 and leads into a distillation unit 24. The solvent line 22 leads from the distillation unit 24 via a further heat exchanger, which can serve to preheat the hydrogen carrier material, in particular along the fluid line 15 between the second storage container 19 and the hydrogenation reactor 13, via the first heat exchanger 11 to preheat the hydrogen gas and via a third heat exchanger 25, which is operated by means of cooling water and serves to cool the solvent, to a solvent storage container 26. The solvent line 22 forms a closed circuit line, i.e. a closed circuit system. A fluid pump 17 can be arranged at a suitable position along the solvent line 22, in particular between the solvent storage container 26 and the second valve unit 23.

The heat required in the distillation unit 24 can be supplied by feeding hot steam via a steam line 27 from the hydrogenation reactor 13. The required heat can also be supplied to the distillation unit 24 by means of another heat exchanger medium, in particular by heated thermal oil. In this case, the line 27 is designed as a heat exchanger line. It is essential that the heat provided in the hydrogenation reactor 13 is made available for distillation in the distillation unit 24.

An additional reactor 28 for hydrogenative deoxygenation is connected to the distillation unit 24. The additional reactor 28 can also be omitted.

A third storage container 29 is connected to the hydrogenation reactor 13, wherein the fluid line 15 is led from the hydrogenation reactor 13 to the third storage container 29 via one of the heat exchangers 12, which is arranged in particular along the fluid line 15 between the second storage container 19 and the hydrogenation reactor 13. After the hydrogenation in the hydrogenation reactor 13, additional further conditioning steps can take place, in particular the removal of physically dissolved hydrogen gas from the at least partially hydrogenated hydrogen carrier medium LOHC-H. The removal of the physically dissolved hydrogen gas can take place by means of a catalyst cartridge and/or by means of a stripping column. In particular, a further conditioning step after hydrogenation is the removal of water from the fluid stream discharged from the hydrogenation reactor 13. The removal of water can be carried out, for example, by means of a separator, a stripping column and/or by adsorptive purification.

Additionally or alternatively, an adsorptive purification of the fluid stream discharged from the hydrogenation reactor 13 can take place, in particular to remove oxygen-containing impurities in the liquid phase after hydrogenation. The third storage container 29 is connected to the output interface 7 of the first system part 2 via a fluid line 15.

A method for operating the first system part 2 is explained in more detail below.

At least partially discharged hydrogen carrier medium LOHC-D and/or LOHC-V is stored in the first storage container 14. The hydrogen carrier material has oxygen-carrying and/or sulfur-carrying components as impurities. The hydrogen medium LOHC-D is conveyed from the first storage container 14 into the first adsorber unit 16 and purified there. For this purpose, selective adsorption takes place by means of a polar adsorbent such as silicon oxide or aluminum oxide. This removes oxygenates in particular from the hydrogen carrier material. The at least partially discharged hydrogen carrier material LOHC-D is purified and is available as purified, at least partially discharged hydrogen carrier material LOHC-D*.

The purified, at least partially discharged hydrogen carrier material LOHC-D* is transferred from the first adsorber unit 16 into the storage container 19 and from there into the hydrogenation reactor 13. By means of hydrogen gas from the electrolyzer, a catalytic hydrogenation reaction takes place in the hydrogenation reactor 13, as a result of which the purified, at least partially discharged hydrogen carrier material LOHC-D* is converted into the at least partially charged form. The purified, at least partially charged hydrogen carrier material LOHC-H* is transferred from the hydrogenation reactor 13 into the third storage container 29 and made available at the output interface 7 as required.

With increasing service life, in particular of the first system part 2, the adsorbent in the first adsorber unit 16 becomes contaminated with the oxygen-carrying and/or sulfur-carrying components and is thus clogged. It is therefore necessary to purge the adsorbent with purge gas at regular intervals, in particular before the capacity of the adsorbent is exhausted, in particular in the opposite direction of the fluid flow of the hydrogen carrier material through the first adsorbent unit 16. When the capacity of the adsorbent is exhausted, the oxygen-containing and/or sulfur-containing and/or halogen-containing impurities break through. The purification of the first adsorber unit 16, i.e. the desorption, takes place in particular with the supply of heat by means of the heating source 18. The desorption is thereby improved. The removal of the oxygen-carrying and/or sulfur-carrying and/or halogen-containing components from the adsorbent is thus simplified and, in particular, possible more effectively. Losses of hydrogen carrier material can be reduced and in particular minimized by regular purification.

Hydrogen carrier material, in particular LOHC-D, located in a cavity region of the adsorbent bed is conveyed back into the first storage container 14 by the purge gas.

Subsequently, the adsorbent bed in the first adsorber unit 16 can be rinsed with a solvent. According to the embodiment example shown, the solvent used is acetone, which is low-boiling and has a polarity greater than that of the adsorbent. As a result, polar substances are displaced from the surface of the adsorbent by the solvent. A solvent stream comprising the oxygenates dissolved from the adsorbent and optionally additionally comprising components of at least partially discharged hydrogen carrier medium LOHC-D which have dissolved from pores of the adsorbent is conveyed to the distillation unit 24 and distilled there. This allows the solvent to be separated from the oxygenates and the hydrogen carrier medium components. The recovered solvent can be recycled via the closed line circuit.

The solvent remaining in the pores of the adsorbent can advantageously be discharged by heating, in particular by supplying heat by means of the heating source 18 and/or by means of an inert gas stream. In particular, it is possible to remove solvent from the adsorbent in order to subsequently feed hydrogen carrier material to the first adsorber unit 16 again. In particular, it is possible to completely remove the solvent from the first adsorber unit 16. It is advantageous if a residual portion of the solvent which cannot be removed, in particular oxygen-containing solvent residues, is smaller than the portion of oxidic impurities in the first adsorber unit 16.

The second system part 3 is explained in more detail below. The second system part 3 has a dehydrogenation reactor 30 which is connected to the input interface 6 of the second system part 3 via a fluid line 15. A recuperator 31 is connected to the dehydrogenation reactor 30, which recuperator 31 is used for heat recovery and in particular for preheating hydrogen carrier material, in particular in the at least partially charged form (LOHC-H). A return line 32 serves for this purpose. A hydrogen carrier material feed line 33 opens into the recuperator 31, which hydrogen carrier material feed line 33 serves to feed cold hydrogen carrier material, in particular in the charged form. A fourth storage container 34 is connected to the recuperator 31, which fourth storage container 34 is connected to the output interface 7 of the second system part 3.

A fluid line 15 leads from the recuperator 31 to a gas cooler 35, which serves as a separation apparatus. Hydrogen gas separated in the gas cooler 35 can be fed to a compressor 36 connected to the gas cooler 35 and then made available as a compressed hydrogen gas stream to a utilization unit 37. A fuel cell, for example, serves as the utilization unit 37.

The second system part 3 has at least one second removal unit 38. The second removal unit 38 serves to remove oxygen-carrying and/or sulfur-carrying components from the released hydrogen gas.

The second removal unit 38 can be designed as a second adsorber unit, in particular by means of zinc oxide and/or copper oxide for adsorption of carbon monoxide and/or hydrogen sulfide, in particular at temperatures between 20° C. to 80° C., and/or as a second catalysis unit, in particular for catalysis of hydrocarbon monoxide to methane, in particular at a temperature of 120° C. to 200° C. when using a ruthenium catalyst.

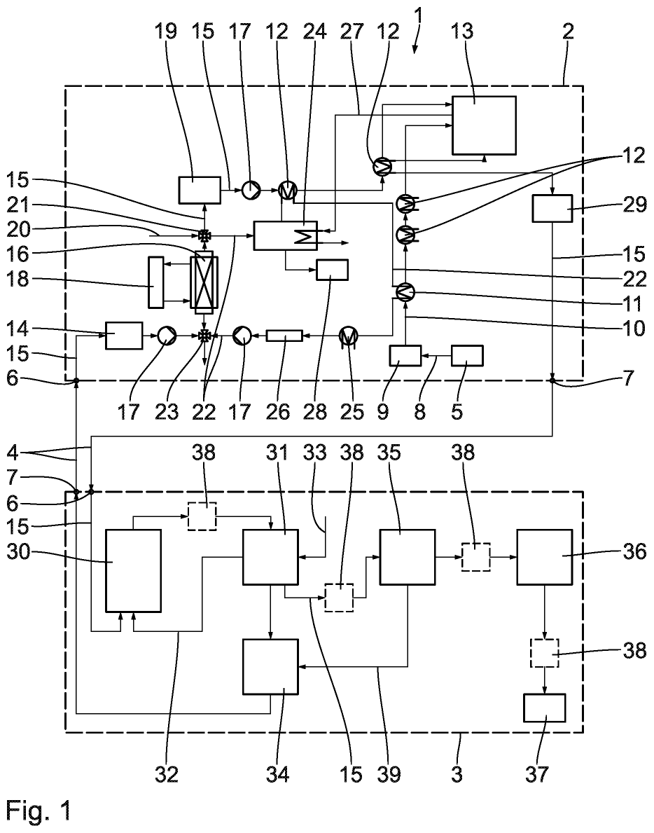

As indicated in FIG. 1 by the dashed representation, the second removal unit 38 can be arranged at different positions, in particular within the second system part 3. The second removal unit 38 can, for example, be arranged along the fluid line between the dehydrogenation reactor 30 and the recuperator 31 and/or along the fluid line between the recuperator 31 and the gas cooler 35 and/or between the gas cooler 35 and the compressor 36 and/or between the compressor 36 and the utilization unit 37.

The method for releasing the hydrogen gas and removing impurities from the released hydrogen gas in the second system part 3 is explained in more detail below.

At least partially charged and purified hydrogen carrier material LOHC-H* is conveyed from the first input interface 6 of the second system part 3 via the fluid line 15 into the dehydrogenation reactor 30, where it is discharged by means of a catalytic dehydrogenation reaction. Discharging means that hydrogen gas is released and that hydrogen carrier material is converted from the at least partially charged form (LOHC-H*) to the discharged form (LOHC-D*). A fluid mixture is transferred from the dehydrogenation reactor 30 to the recuperator 31 and cooled there, in particular by means of a cold stream of at least partially charged hydrogen carrier medium (LOHC-H). In the process, volatile components of the at least partially charged, purified hydrogen carrier material condense, which can be returned preheated to the dehydrogenation reactor 30 via the return line 32.

The separated, at least partially discharged hydrogen carrier material LOHC-D* is discharged from the recuperator 31 and collected in the fourth storage container and made available at the output interface 7 of the second system part 3 as required. A partially cooled hydrogen gas stream with a moderate proportion of hydrocarbons in the gas is conveyed from the recuperator 31 into the gas cooler 35. The proportion of hydrocarbons in the gas is in particular at most 10,000 ppmv, in particular at most 1,000 ppmv and in particular at most 500 ppmv. As a result of the cooling, further constituents of the hydrogen carrier material are separated, in particular by condensation, and returned to the fourth storage container 34 via a further return line 39.

The hydrogen gas stream cooled in the gas cooler 35 is transferred to the compressor 36 where it is compressed and made available as a compressed hydrogen gas stream with a low hydrocarbon content, in particular at low temperature and high pressure for the utilization unit 37. In particular, the hydrocarbon proportion in the compressed hydrogen gas stream is at most 2,000 ppmv, in particular at most 500 ppmv, in particular at most 50 ppmv and in particular at most 2 ppmv.

It has surprisingly been found that the two-step purification method with the removal of impurities in the liquid hydrogen carrier material in a first purification step and the removal of impurities in the released hydrogen gas in a second purification step is very efficiently and economically possible. In particular, it may be sufficient if the first purification step of the hydrogen carrier material is performed only once. The hydrogen carrier material purified in this way can in particular be charged and discharged several times without the need for further purification steps of the liquid hydrogen carrier material. A single purification is sufficient in particular if the purified hydrogen carrier material is protected from oxygen contamination, in particular also by LOHC oxidation, during subsequent transport and/or subsequent storage.

With the system 1, hydrogen gas can be made available with increased purity, in particular for the utilization unit 37. The effort for purification of the hydrogen gas stream by means of pressure swing adsorption is reduced. The costs required for this for investment and operation in pressure swing adsorption can be reduced and in particular avoided. Through the reduced use of pressure swing adsorption, hydrogen losses can be reduced, in particular to less than 4%, in particular less than 3%, in particular at most 2% and in particular at most 1%.

1. A method for providing hydrogen gas comprising the method steps of:
providing a liquid hydrogen carrier material;
removing oxygen-carrying and/or sulfur-carrying and/or halo-gen-containing components from the liquid hydrogen carrier material;
releasing hydrogen gas by catalytic dehydrogenation of the purified hydrogen carrier material; and
conditioning the released hydrogen gas.

2. The method according to claim 1, further comprising removing at least one of the oxygen-carrying components and/or sulfur-carrying components and halogen-containing components from the liquid hydrogen carrier material by means of adsorption.

3. The method according to claim 2, further comprising the use of at least one polar adsorbent, and based on activated carbon.

4. The method according to claim 3, further comprising a regeneration of the polar adsorbent by means of at least one of a purge gas stream and a solvent stream.

5. The method according to claim 2, wherein the removal of the oxygen-carrying components and/or the sulfur-carrying components and/or the halogen-containing components from the liquid hydrogen carrier material is carried out at least one of at a temperature of at most 350° C. and at a pressure of at most 50 bara.

6. The method according to claim 1, wherein the conditioning comprises removing at least one of oxygen-carrying components and sulfur-carrying components from the released hydrogen gas.

7. The method according to claim 1, further comprising characterized by removing at least one of the oxygen-carrying components and sulfur-carrying components from the released hydrogen gas by means of catalysis.

8. The method according to claim 6, wherein the removal of at least one of the oxygen-carrying components and sulfur-carrying components from the released hydrogen gas takes place at least one of at a temperature of at most 350° C. and at a pressure of at most 800 bara.

9. The method according to claim 1, further comprising at least one of a storage and transport of the purified liquid hydrogen carrier material which is protected.

10. The method according to claim 1, wherein at least one of oxygen-carrying components in the released hydrogen gas are less than 200 ppmv and sulfur-carrying components in the released hydrogen gas are less than 1 ppmv.

11. A system for providing hydrogen gas, the system comprising:
a first removal unit for removing oxygen-carrying and/or sulfur-carrying and/or halogen-containing components from liquid hydro-gen carrier material;
a dehydrogenation reactor for releasing hydrogen gas by catalytic dehydrogenation of the hydrogen carrier material; and
a second removal unit for conditioning the released hydrogen gas.

12. The system according to claim 11, wherein the first removal unit is a first adsorber unit comprising a polar adsorbent.

13. The system according to claim 12, wherein a solvent line is connected to the first adsorber unit.

14. The system according to claim 12, wherein a purge gas line is connected to the first adsorber unit.

15. The system according to claim 12, further comprising a hydrogenation reactor which is fluidically connected to the first adsorber unit.

16. The method according to claim 7, further comprising using at least one selective catalyst material comprising at least one of nickel, copper, cobalt, molybdenum and noble metal.

17. The method according to claim 9, wherein the transport which is protected is a protected transport of the purified liquid hydrogen carrier material from a first location, where at least one of the oxygen-carrying components and the sulfur-carrying components and the halogen-containing components have been removed from the liquid hydrogen carrier material, to a second location, where the hydrogen gas is released.

18. The system according to claim 13, wherein a distillation unit connected to the solvent line is connected to the first absorber unit.
